(19) United States
(12) Patent Application Publication
(10) Pub. No.: US 2009/0258963 A1
(43) Pub. Date: Oct. 15, 2009

(54) LIQUID ACRYLIC ELASTOMER

(75) Inventor: Michael J. MOORE, Sylvania, OH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 12/100,725

(22) Filed: Apr. 10, 2008

(51) Int. Cl. C08F 2/46; C08G 59/00; C08L 73/00

(52) U.S. Cl. 522/100; 525/384; 524/599

(57) ABSTRACT

Curable compositions of epoxy-functional acrylic resins having low viscosity and high epoxy functionality, gaskets, seals, elastomeric pottings, and coatings, and other articles prepared therefrom, and methods for preparation of these.

### BACKGROUND

The present disclosure relates to improved epoxy-functionalized liquid acrylic elastomers curable to form sealing articles and compositions. Epoxy-functionalized acrylic polymers and their curable compositions are useful, e.g., as co-curing agents for polymeric powder coating resins. Such polymers typically have a high viscosity and low epoxy content that, as presently identified, limits their range of uses.

However, such polymers have properties that could be advantageously employed in, e.g., gaskets and other seals, if an appropriate combination of polymer characteristics and curing system were provided. Thus, it would be advantageous to develop curable, epoxy-functional acrylate polymeric materials having improved usefulness in the fields of gaskets, seals, and similar articles, and that are capable of use in “cure-in-place” gasketing compositions.

### SUMMARY

Various embodiments hereof provide curable, epoxy-functional acrylate polymeric materials having improved usefulness in the fields of gaskets, seals, and similar articles. Novel polymers and polymer-curing system compositions are also provided. The compositions are also useful for “cure-in-place” gasketing.

In particular, in various embodiments, the present technology provides: curable compositions containing (A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; and (B) 0.1-30 PHW of a curing system selected from the group consisting of epoxy-curative amine curing systems, acid curing systems, and photoinitiator curing systems;

Curable compositions containing (A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; (B) 0.1-30 PHW of an acid curing system; and (C) 0.1-100 PHW of a reactive diluent component that comprises en epoxy-functional reactive diluent; with the composition exhibiting a room temperature shelf life as a one-pot formulation of about or more than one month;

Commercial packages containing a curable composition with instructions for its use to prepare a gasket, O-ring, potting, stopper, seal, sheet, or coating, wherein the curable composition contains: (A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; and (B) 0.1-30 PHW of a curing system selected from the group consisting of epoxy-curative amine curing systems, acid curing systems, and photoinitiator curing systems; and

Articles made of a material that is the curing reaction product of a curable composition comprising: (A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; and (B) 0.1-30 PHW of a curing system selected from the group consisting of (1) epoxy-curative amine curing systems with room temperature or elevated temperature applied to the composition, (2) acid curing systems with elevated temperature applied to the composition, and (3) photoinitiator curing systems with actinic radiation applied to the composition.

Compositions and materials of this technology provide benefits over compositions and methods among those known in the art. Such benefits include, in various embodiments, one or more of low viscosity, high level of epoxy functionality, and that compositions can be provided in one-part (single-pot) formats that exhibit stability sufficient for transport time and shelf life. Further areas of applicability will become apparent from the description provided herein.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition or method.

The citation of references herein does not constitute an admission that those references are prior art or have any relevance to the patentability of the technology disclosed herein. Any discussion of the content of references is intended merely to provide a general summary of assertions made by the authors of the references, and does not constitute an admission as to the accuracy of the content of such references. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, and methods of this technology. “A” and “an” as used herein indicate “at least one” of the item is present; a plurality of such items may be present, when possible.

Abbreviations used herein include mol. % (mole percent), wt. % (weight percent), and PHW (parts per hundredweight of resin). Aliphatic groups hereof, e.g., alkane or alkene radicals, can be from C1 to C20 in size, such as C1-C12, C1-C10, C1-C8, C1-C6, or C1-C4.

In various embodiments the present technology provides novel, curable, low-viscosity, epoxy-functional acrylic compositions. Such compositions are useful, for example, for forming sealing articles such as gaskets, “cured-in-place” gaskets, screen-printed gaskets, O-rings, pottings, stoppers, seals, static seals, radial shaft seals, sheets, coatings, and the like.

### Epoxy-Functional Acrylic Resins

Epoxy-functional acrylic resins useful in the present technology can be prepared by copolymerizing acrylic monomer(s) with epoxy-functional acrylic monomer(s). Examples of useful acrylic monomers include acrylic acid (2-propenoic acid), alkyl-substituted acrylic acids, alkyl esters thereof, and their salts; in various embodiments, alkyl groups thereof can be C1-C8 alkyl, with C1-C6 or C1-C4 being desirable in some embodiments. Methacrylic acid, ethacrylic acid, crotonic acid (e.g., trans-crotonic acid), tiglic acid, and angelic acid can be used, though acrylic and/or methacrylic are typically selected. Esters include methyl, ethyl, and/or butyl esters; ethyl and/or butyl esters are preferred in some embodiments. In a given resin, one or more than one type of acrylic monomer can be selected. In some embodiments, the acrylic monomers can be selected from among methyl acrylate, ethyl acrylate, butyl acrylate, t-butyl acrylate, and 2-ethyhexyl acrylate.

Examples of useful epoxy-functional acrylic monomers include those having a structure comprising that of any one of the above-described acrylic monomers and further comprising an epoxy substituent, e.g., an oxiranyl- or glycidyl-substituent. Thus, useful epoxy-functional acrylic monomers include oxiranyl- or glycidyl-substituted acrylic monomers, e.g., oxiranyl- or glycidyl-esters of an acrylic or methacrylic acid. The epoxy-containing moiety can be attached to the unsaturated portion of the monomer by ester linkage, or by another useful linkage, e.g., an ether, thioester, or thioether, linkage. Ester and/or ether linkage(s) can be selected for use in some embodiments hereof. In various embodiments, glycidyl methacrylate can be selected as the epoxy-function acrylic monomer.

Other monomers can also be used in copolymerization reactions hereof. If used, such other monomers can be present at about or less than 20, 15, 10, 5, 3, 2, or 1 mol. %. For example, vinyl, allyl, or other unsaturated hydrocarbon monomers that can be polymerized by free-radical solution polymerization can be used, e.g., styrene; or 3-butenoic or alkyl-substituted 3-butenoic acid monomers or their alkyl esters or salts; in the case of other epoxy-functional monomers, these can include any of, e.g., oxiranyl- or glycidyl-allyl, -vinyl, -methallyl, or -isopropenyl ethers. Further epoxy-functional monomers useful in some embodiments hereof include epoxy C3-C8 alkenes, e.g., 3,4-epoxy butene, 4,5-epoxy pentene, and the like, in which the epoxy-containing moiety can be a terminal oxirane group involving two of the carbon atoms of the monomer's carbon skeleton. In various embodiments, monomers hereof can be fluorinated, perfluorinated, or substantially or totally fluorine-free.

Monomers are preferably selected so that the resulting acrylate polymers of a resin hereof have an average epoxy functionality that is 3 or more. In various embodiments the average epoxy functionality can be 4, 5, or 6 or more, or any fractional value greater than 3, e.g., 3.1; and this value can be 10 or less, typically 8 or less, 6 or less, or 5 or less. Resin polymers hereof also can have an epoxy equivalent weight (EEW) that is less than or about 2000, and this can be at least or about 100, 600, 700, 800, 900, or 1,000, and up to or about 1800, 1600, 1500, 1400, 1300, or 1200. The acrylate polymers of a resin can also have a relatively short chain length, as one route for providing low viscosity, as further described below. As a result, within a given viscosity range, the average chain length of a batch of resin polymers can be a function of a desired epoxy functionality and a desired EEW. Thus, in some embodiments, the epoxy-functional acrylate polymers of a resin hereof can have an average molecular weight (Mw) that is at least or about 1500 Daltons and up to or about to about 4200 Daltons. However, higher Mw resin polymers can be used; and in some curable compositions thereof, a resin diluent, such as an epoxy-functional diluent, can be included so as to modify the viscosity of the combination.

The epoxy-functional acrylic resin of a composition hereof can be a low-viscosity resin, having a viscosity of less than 10,000 cP, as determined at 25° C.; this can be at least or about 10, 50, or 100 cP and/or less than or about 5,000, 2,000, 1,000, or 500 cP; in some embodiments, the viscosity can be from about 10 to about 500 cP. Resin viscosity can be determined according to standard procedure ASTM D1725-04. In some embodiments, the combination of an epoxy-functional acrylic resin and an optional epoxy-functional diluent can exhibit the stated viscosity. The viscosity of the epoxy-functional acrylic resin is a function of the polymer's molecular weight. The factors controlling molecular weight are well understood and include polymerization temperature, initiator concentration, monomer concentration, and the use of chain transfer agents. Increasing any of these four factors results in a decreased molecular weight. Thus, any of the polymerization conditions known useful to one of ordinary skill in the art for the purpose can be employed to prepare an epoxy-functional acrylic resin hereof.

In some embodiments, a curable composition hereof can contain an epoxy-functional acrylic resin and a reactive, resin diluent, further described below. When such a resin diluent is used, the combination of resin(s) and diluent(s), exclusive of other components of the curable composition, can contain up to or about 50 wt. % of the diluent(s), or up to or about 40, 30, 25, 20, 15, or 10 wt. % thereof, and this can be at least or about 1, 2, 3, 5, or 10 wt. %. The diluent can make up from about 10 to about 20 wt. % of the combination. In terms of PHW units, the diluent(s) can be added in a concentration of 100 PHW or less (i.e. 50 wt. %), 50 PHW (i.e. 25 wt. %), and so forth.

### Resin Diluents

In various embodiments, a curable composition includes a reactive, resin diluent. This can be an epoxy-functional diluent (EFD). Useful EFDs can be mono-, di- or poly-functional. In some embodiments, the EFD is preferably selected from the di- and poly-functional epoxy diluents. Examples of mono-functional diluents include butyl glycidyl ether, 2-ethylhexyl glycidyl ether, and cresyl glycidyl ether (ARALDITE DY 023®, available from Vantico Inc., Los Angeles, Calif., US). Useful difunctional epoxy diluents include the diglycidyl ether of butanediol (ARALDITE RD-2®, Vantico) and the diglycidyl ether of polypropylene glycol (ARALDITE DY 3601®, Vantico). Polyfunctional diluents include the triglycidyl ether of trimethylolpropane (ARALDITE DY-T®, Vantico) and an epoxidized cashew nut shell liquid-based reactive diluent (ARALDITE XU 396®, Vantico).

HELOXY® brand epoxy-functional diluents are also useful herein, and are available from Hexion Specialty Chemicals, Inc. (Houston, Tex., US). Conventional liquid epoxy resins based on bisphenol A (EPON 828®, Hexion; or DER 331®, Dow Chemical Co., Midland, Mich., US) or epoxidized phenolics can be used, alternatively or in addition, although these are typically not as effective at reducing viscosity.

Cycloaliphatic diepoxides can also be used as reactive diluents, and are particularly useful in embodiments in which the curable composition is to be cured using a cationic (acid) catalyzed cure. Useful cycloaliphatic epoxies include CRYACURE® and ERL® (Dow), as well as those available from Sartomer Co. (Exton, Pa., US) and Hexion. A cycloaliphatic epoxy blend with about 10 wt. % of a phenoxy resin can be used in some embodiments (CER-CP679® from In-Chem. Inc., Rockhill, S.C., US).

In addition to, or instead of, an epoxy-functional diluent, a polyol diluent can be used in some embodiments. A trifunctional polyol based on polycaprolactam (Mn=300) is one useful example thereof (TONE 0301®, Dow). Where more than one reactive resin diluent is used in a curable composition, the total weight of the diluents will still fall within the concentration ranges described above. Where a curable composition hereof comprises both epoxy-functional acrylic resin(s) and reactive diluent(s), the viscosity of a resin-diluent admixture of the resin(s) and diluent(s), in the same proportions as used in the curable composition, will have a viscosity value as described above. Thus, the resin and diluent components of a diluent-containing composition hereof will be capable, if formed into such an admixture, of jointly exhibiting a viscosity less than 10,000 cP at 25° C. In various embodiments hereof, EFD(s) used in a given formulation can be free of complex, cycloaliphatic side group-containing acrylate monomers, e.g., nonarmoatic side-groups having more than 6 cycloaliphatic ring skeleton carbon atoms.

### Curing Systems

Curing systems have now been developed for use in curing the epoxy-functional acrylic resins or the resin-diluent systems hereof. Each of amine, acid, and photoinitiator curing systems are useful in various embodiments of curable compositions.

Amine Curing Systems. In some embodiments, an amine curing system is used that comprises a multifunctional amine or multifunctional amide and, optionally, a tertiary amine accelerator. In embodiments employing an amine curing agent, the aliphatic, cycloaliphatic, and blocked amines are useful. The aliphatic amines can be simple multifunctional amines such as diethylene triamine (EPIKURE 3223®, Hexioin), triethylene tetraamine (EPIKURE 3224®, Hexion), or tetraethylene pentaamine (EPIKURE 3245®, Hexion). Another suitable class of amines is the polyalkoxy-endcapped amines, such as diaminopolypropylene glycol (JEFFAMINE D® series, Huntsman). Examples of useful blocked amines include ketimines, e.g., EPIKURE 3052® (Hexion), or the dicarbamate of hexamethylenediamine (DIAK #1®, DuPont). Blocked amines can be particularly useful for extended pot-life formulations.

For embodiments employing an amide curing system, examples of useful amides include the polyamides, e.g., EPIKURE 3125® (Hexion) or VERSAMID 150® (Cognis). For use in either an amine or amide curing system, a tertiary amine can be added as an accelerator to enhance the catalytic ring opening of the epoxy group. Triethanolamine can be used. One example of a commercially available catalyst is the blended catalyst Accelerator 399 (Huntsman).

When formulating epoxy-functional materials with an amine curing agent, it is preferable to stoichiometrically balance the concentration of epoxy groups with the concentration of curing agent amine or amide groups, as is well known to one of ordinary skill in the art.

In the presence of a tertiary amine catalyst, it is also possible to cure the epoxy-functional oligomer with a polyol or a polyfunctional carboxylic acid as alternative (non-amine) curing agent. An example of a polyol that is suitable is the acrylic polyol ACRYFLOW P120® (Lyondell).

In embodiments in which an amine or amide curing system is used, the curable composition can be cured at room temperature over several days (e.g., about 72 hours) or by heating to an elevated temperature above 25° C. and about or less than, e.g., 250° C. or 200° C. In various embodiments, the elevated temperature can be at least or about 80° C. or 100° C., and/or up to or about 120° C. or 140° C. Such elevated temperatures can be maintained for about 2-3 hours to cure the composition.

Acid Curing Systems. In some embodiments, an acid curing system is used that comprises an acid catalyst and, optionally, a polyol-functional reactive diluent(s). In various embodiments, a curable composition comprising such an acid catalyst curing system is stable as a one-part system for at least one-month, until it is cured at elevated temperature.

Useful acid catalysts include blocked or latent acid catalysts that undergo thermal decomposition to release free acid that is then operative to initiate curing. Suitable super acids include trifluoromethylsulfonic acid (triflic acid), hexafluoroarsenic acid, and hexafluorophosphoric acid. For example, α,α-dimethylbenzylpyridinium hexafluoroantimonate is a blocked catalyst that permits cure of glycidyl methacrylate (GMA) copolymers using a cycloaliphatic epoxy as a reactive diluent while retaining an adequate pot life, as described in Z. Wicks et al., Organic Coatings: Science and Technology, p. 225 (1999) (Wiley Interscience, NY).

Photoinitiator curing systems. In some embodiments, a photoinitiator curing system can is used that comprises a cationic photoinitiator and, optionally, a polyol-functional reactive diluent(s). A curable composition comprising such a photoinitiator curing system can be cured by exposure to actinic radiation (e.g., UV or electron-beam).

In various embodiments, curing agents (exclusive or reactive diluents) are added to the composition at a concentration of about 0.5 to about 20 PHW, i.e. per hundredweight of resin. Accelerators and other curing system components, further described below, if present, can typically be added at a concentration of about 10 PHW or less, or more commonly about 5 PHW or less, and typically at least or about 0.1 PHW. Thus, the total amount of curing system components added to the composition is typically about 30 PHW or less, or about 25, 20, 15, or 10 PHW or less, and at least or about 0.1 PHW.

Other Curing System Components. In some embodiments, a curable composition can be cured using any of the above types of curing agents in a multi-component curing system that can contain any one or more of, e.g., co-curing agents, cross-linking agents, activators, accelerators, and other curing- or vulcanization-enhancing additives, in addition to the primary curing agent(s), known useful to one of ordinary skill in the art. In various embodiments, a curing system hereof can be free of imidazole as a curing agents or other functional component.

### Other Additives

Further additives can be included in curable compositions of the present technology, including such additives that are known in the polymer arts. Examples of such additives include processing aids (e.g., surfactants, lubricants, plasticizers, mold-release agents), colorants (e.g., inorganic or organic pigments, dyes), fillers (e.g., carbon black, graphite, silica, talc, clay, diatomaceous earth, calcium carbonate, inert polymeric particulate, such as PTFE particulate, fluorosilicones), anti-static agents (e.g., conductive inorganic particulate, conductive polymers), stabilizers (e.g., UV light stabilizers), and anti-degradants (e.g., anti-oxidants). In some embodiments, the additives include a pigment, e.g., Phthalocyanine Blue BGS (Pigment Blue 15:3), and/or a filler, such as silica.

### Processing

To prepare a curable composition, the components selected therefor can be added together in any order known useful in the art. Typically, a diluent, if present, is mixed with the resin, followed by other additives that are mixed into the resin (or reside-diluent combination), and then the curing system components are added thereto and mixed until homogeneous. The resulting curable composition can then be formed (e.g., molded, extruded, or spread) to prepare a shape for an article, applied as a potting or screen-printing composition or as a cure-in-place gasket and the like, or in the case of shelf-life stable compositions can be packaged for storage. Where elevated temperature is used to effect curing, the temperature can be so elevated when desired, typically upon completion of shaping. In the case in which curing is performed before preparing a shaped article, the resulting cured material can be cut or abraded to prepare the shaped article.

### Applications

The curable compositions described herein can be used, for example, for “cured-in-place” gaskets (CIPG), screen-printed gaskets, electronic encapsulation, and/or potting for sensors in automotive fluids, e.g., automatic transmission sensors, sealing T-joints, i.e., the location where a front cover, pan and block connect in an engine.

With respect to screen-printing, a manufacturing advantage in various embodiments is that the coating is 100% solids. There are no solvents to flash off. Drying on a screen is reduced, particularly if a stable 1-part system is used.

The following are non-limiting examples of the composition and methods of the present technology.

### EXAMPLES

### Example 1

### Development of Curing Systems

Four different formulations are made to test the usefulness of various curing agents in curing a comparative epoxy-functional acrylic resin. Formula compositions are shown in Table 1:

TABLE 1
Formula Compositions

| | | Formulations (g) | | | |
|---|---|---|---|---|---|
| Components | PHW | No. 1 | No. 2 | No. 3 | No. 4 |
| Epoxy-acrylic resin #1 | 100 | 5 | 5 | 10 | 5 |
| ACRYFLOW P120 ® polyol | 16.0 | 0.8 | | | |
| EPI-CURE 3125 ® polyamide | 13.0 | | 0.65 | | |
| EPIKURE 3234 ® | 0.4 | | | 0.1 | |
| triethylenetetramine | | | | | |
| JEFFAMINE D-2000 ® | 18.5 | | | | 0.92 |
| polyoxypropylenediamine | | | | | |
| ACCELERATOR 399 ® | 5 | 0.25 | 0.25 | 0.50 | 0.25 |

PHE = parts per hundredweight of epoxy resin

Components are as follows: Epoxy-acrylic resin #1 having an epoxy equivalent weight (EEW) of about 2,300, i.e. about 2.1 mol. % epoxy monomer, giving an epoxy functionality of about 2.1 for mono-epoxy monomers (e.g., glycidyl methacrylate). Epoxy-acrylic resins are prepared by free-radical polymerization of acrylate and epoxy-functional acrylate monomers in emulsion (or in solution), e.g., in refluxing toluene. After reaction, the solvent is removed, e.g., evaporated off, leaving the resin.

Other components of Formulas 1-4 include: ACRYFLOW P120® low-VOC, liquid acrylic polyol curing agent, from Lyondell Chemical Co. (Houston Tex., US); EPI-CURE 3125® medium viscosity, reactive polyamide curing agent, from Shell Chemicals Ltd. (London, UK); EPIKURE 3234® low viscosity, liquid, triethylenetetramine curing agent, from Hexion Specialty Chemicals, Inc. (Houston, Tex., US); JEFFAMINE D-2000® polyoxypropylenediamine curing agent, from Huntsman Corp. (The Woodlands, Tex., US); and ACCELERATOR 399® piperazine, N-aminoethylpiperazine, and triethanolamine epoxy-cure accelerator, from Huntsman.

The four formulas are mixed in a high shear, centrifugal mixer to a uniform consistency. The samples are dispensed from a syringe onto a steel panel and cured at 175° C. The samples are checked for periodically to assess their curing times.

All four formulations cure, and are of sufficient viscosity to be dispensed from a syringe. Formula 3 cures the slowest, taking over 10 min, the remaining formulas all curing in less than 10 min, with formula 4 curing the fastest (data not shown).

### Example 2

### Development of Filled Resin System

Example 1 is modified by adding fumed silica to decrease slumping or sagging of the dispensed bead during cure. A composition of formula 2 is then prepared using a silica filler, as shown in Table 2.

TABLE 2
Silica-Filled Formulation Composition

| Components | PHW | Wt. (g) |
|---|---|---|
| N65-84 epoxy-acrylic resin | 100 | 5 |
| EPI-CURE 3125 ® polyamide | 13 | 0.65 |
| ACCELERATOR 399 ® | 5 | 0.25 |
| R972 ® silica particles | 3 | 0.15 |

R972 ® silica particles are hydrophobized silica, i.e. silica that has been surface treated with dichlorodimethylsilane, from Degussa GmbH (Düsseldorf, DE).

A bead of the above material is dispensed from a syringe onto a steel plate and cured for 10 minutes at 175° C. The silica-filled composition exhibits greatly decreased spread, with much improved maintenance of the bead height and shape extruded from the syringe (data not shown).

### Example 3

### Development of Epoxy-Functional Acrylic Resin

Methods for preparing epoxy-functional acrylic resins are known in the art and the techniques useful therefor can be employed herein. Acrylic polymers are prepared by free-radical polymerization either in emulsion or in solution. The sizes of the polymers hereof are on the order of oligomers.

An epoxy-functional acrylic oligomer, designated PCC 561063, is prepared as follows. To a three-neck 1 liter flask, 200 g toluene is charged. The flask is heated to the reflux point of toluene (110-111° C.). In a separate flask, a blend of monomers consisting of 210 g ethyl acrylate (EA), 45 g butyl acrylate (BA) and 45 g glycidyl methacrylate (GMA) is prepared. This is equivalent to a blend of 70/15/15 EA/BA/GMA. The EEW at 15 weight percent GMA is 948. To this monomer blend, 6 g of azoisobutyronitrile (AIBN), a known free radical initiator, is dissolved. The mixture of initiator and monomers is charged to an addition funnel attached to the three-neck flask. With stirring and a nitrogen purge, the monomer blend is slowly dripped into the refluxing toluene over a period of about 2 hours. The vessel is held at reflux for an additional hour to complete the polymerization. The resulting polymer solution is about 61% solids.

The polymer solution is discharged to a tray and the bulk of the solvent is removed over several days. The tray is then heated in an oven at about 80° C. for two hours to remove residual solvent. The resulting acrylic oligomer can be poured from the tray at elevated temperature. It flows under its own weight at room temperature.

General considerations: Other free radical initiators can be used. Known free radical initiators include organic peroxides and azo compounds. The initiator is selected to have an appropriate decomposition half life at a given polymerization temperature. In embodiments in which a solvent-containing formulation is used to prepare the curable composition, the solvent(s) elected for use in the polymerization process is chosen to have an appropriate boiling point. In commercial practice, solution polymerization of acrylates is conducted under reflux conditions as a matter of safety and convenience. Solvents may be polar or non-polar. Protonated solvents such as alcohols are known to provide abstractable hydrogens that can terminate growing polymer chains. Typically the solvent is 50 to 60% of the solution polymer formulation batch weight.

### Example 4

### Curing Compositions Using the Novel Resins

The following composition is prepared to test the curing properties of the epoxy-functional acrylic resin prepared in Example 3:

| Component | PHW | (g) |
|---|---|---|
| PCC 561063 | 100 | 5.00 |
| Jeffamine D-400 | 12.1 | 0.54 |
| Accelerator 399 | Trace | Trace |

A thin film of this material is coated on an aluminum panel and cured at 200° C. for 10 minutes. A tough film is produced. An additional sample is smeared on a panel at several millimeters thick and allowed to sit at room temperature for several days. This example also cured at room temperature.

A second, novel epoxy-functional acrylic resin (EpAc #2) is also tested, in order to assess the effect of the use of an epoxy-functional diluent. The formula is provided below:

| Component | (g) |
|---|---|
| EpAc #2 | 43.86 |
| Araldite RD-2 | 10.97 |
| Jeffamine D-400 | 15.17 |
| Accelerator 399 | 0.50 |
| R972 fumed silica | 5.25 |
| Pigment Blue 15:3 | 3.50 |

Coatings of this EpAc#2 formulation are prepared on aluminum panels at 3 and 6 mil wet thickness. The coatings are cured at 150° C. for approximately 30 minutes. The resulting films are tough and exhibit adhesion to the aluminum panel. It is also observed that the quality of the coating improves with further aging, suggesting addition cure at room temperature. It was further observed that this formulation readily accepted fillers without a significant increase in viscosity. The viscosity appears to be adequate for screen-printing or robotic dispensing through a syringe.

Next, a bead of the EpAc#2 formulation is dispensed from a bench-top, robotically-controlled syringe onto an aluminum panel. The bead is readily dispensed at the minimum level of air pressure (11 psi). The bead is then cured at 150° C. for about 15 minutes. The cured bead is elastomeric and exhibits good adhesion to the aluminum.

### Example 5

### Development of Stable One-Pot Curable Compositions

It is realized that it would be advantageous to substantially increase the useful pot-life of the curable composition above that possessed by those of Example 4. Because of the short pot-life of the Example 4 compositions, they would generally be prepare and stored, for commerce, as 2-component systems. It has been unexpectedly discovered that, by replacing the amine curing system of the Example 4 formulations with an acid curing system, an epoxy-functional acrylate resin-plus-cycloaliphatic epoxy diluent combination exhibited sufficient stability that it can be stored for at least 1 month as a one-pot system at room temperature. The test system employed a polyol and a superacid catalyst as curing system, and the comparative resin of Example 1 as the epoxy-functional acrylic resin.

Five formulations are prepared to test the acid cure approach. These are shown in the table below (weights shown in grams).

| Component | 5-1 | 5-2 | 5-3 | 5-4 | 5-5 |
|---|---|---|---|---|---|
| Epoxy-acrylic resin #1 | 5.00 | 6.57 | 5.32 | 5.25 | 5.14 |
| CER-CP67 | 0.88 | 1.16 | 0.94 | 2.25 | 2.20 |
| Tone 0301 | — | 0.52 | 0.84 | — | 1.65 |
| KI85 | ~0.2 | ~0.2 | ~0.2 | ~0.2 | ~0.2 |

CER-CP67® is an epoxy-functional reactive diluent that is a cycloaliphatic epoxy blend with about 10 wt. % of a phenoxy resin (from In-Chem. Inc., Rockhill, S.C., US). Formulas are prepared with the resin and diluent blend at two levels. Optionally Tone 0301 is added as a supplemental, reactive polyol diluent. KI85 is a sulfonium-based initiator (no longer commercially available).

Beads of the above five formulas are dispensed onto aluminum panels and cured at 200° C. for 10 minutes. All examples cured. The beads of all samples sagged to some degree.

Formulation 5-5 exhibits the most sagging. An additional sample is prepared in which R972 fumed silica is added to formula 5-5 at about 10 parts by weight. A bead is dispensed and cured at 200° C. for 10 minutes. The bead retains its shape through the cure. Thus, by using the low viscosity acrylic oligomer blended with epoxy diluent, it is possible to formulate a material with higher levels of fillers to improve the physical properties and reduce the cost.

### Example 6

### Development of Solventless Epoxy-Functional Acrylic Resin

An epoxy-functional acrylate resin is prepared from a formulation using a reactive diluent and no solvent, as follows. To a three-neck 1 liter flask, 150 g of butanediol diglycidyl ether (Vantico RD-2) is charged. The flask is heated to about 150° C. In a separate flask, a blend of monomers of 70/15/15 EA/BA/GMA, as described above under Example 3, is prepared. To 600 g of the 70/15/15 monomer blend, is added 2% azoisobutyronitrile (AIBN) by weight of the final composition, and this is dissolved therein. The mixture of initiator and monomers is charged to an addition funnel attached to the three-neck flask. With stirring and a nitrogen purge, the monomer blend is slowly dripped into the divalent reactive diluent over a period of about 2 hours. The vessel is held at temperature for an additional hour to complete the polymerization. No step of solvent removal/evaporation is employed. The resulting polymer resin preparation flows readily. Various fillers and curatives are added to prepare different formulations thereof. These perform well (data not shown) and can be formulated as stable, one-pot compositions, e.g., as described above under Example 5. The use of a low viscosity epoxy as reactive diluent is significant because it can further decrease the manufacturing cost of the material.

Thus, in various embodiments, a curable composition hereof can be solventless, and in some embodiments, the solventless curable composition can itself be formed from a solventless formulation. Where a solventless formulation is used, this can be a combination of an epoxy-functional monomer or monomer blend and a reactive, epoxy- and/or hydroxy-functional diluent as described herein, although in some embodiments, a solvent-containing formulation can be used, wherein the solvent(s) is removed to obtain the solventless curable composition. The solventless curable compositions and solventless formulations hereof can be described with reference to those that are, e.g., “solventless” or “free of solvent”, or that contain “no solvent,” that contain “substantially no solvent,” e.g., less than 2%, preferably less than 1%, by weight, or those that are “essentially solvent free,” e.g., containing less than 1%, preferably less than 0.5 or 0.1%, by weight, of solvents. Also, in various embodiments, the curable composition or oligomer/monomer formulation used to prepare it, can be free of urethane acrylic oligomer. Similarly, these can be free of thermoplastic adhesive materials such as a polyester, a polyamide, or a block copolymer of styrene and butadiene.

The examples and other embodiments described herein are exemplary and not intended to be limiting in describing the full scope of materials, compositions and methods of this technology. Equivalent changes, modifications and variations of specific embodiments, materials, compositions and methods may be made within the scope of the present technology, with substantially similar results.

What is claimed is:

1. A curable composition comprising:
(A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; and
(B) 0.1-30 PHW of a curing system selected from the group consisting of epoxy-curative amine curing systems, acid curing systems, and photoinitiator curing systems.

2. The composition according to claim 1, wherein the resin has an epoxy functionality of from 3 to about 10.

3. The composition according to claim 1, wherein the resin has an epoxy equivalent weight from about 600 to about 1800.

4. The composition according to claim 1, wherein the composition further comprises a reactive, resin diluent.

5. The composition according to claim 1, wherein the diluent comprises a mono-, di-, or tri-functional epoxy diluent.

6. The composition according to claim 1, wherein the curing system is an amine curing system and said system is one that utilizes a multifunctional amine curing agent.

7. The composition according to claim 6, wherein said curing system further comprises a tertiary amine accelerator.

8. The composition according to claim 1, wherein the curing system is an acid curing system and the composition further comprises a polyol-functional reactive diluent.

9. The composition according to claim 1, wherein the curing system is a photoinitiator curing system and the composition further comprises a polyol-functional reactive diluent.

10. The composition according to claim 9, wherein the photoinitiator of the curing system is selected to be one that is sensitive to UV light such that UV light can be used to initiate the curing reaction of the curable composition.

11. The composition according to claim 1, wherein the composition further comprises a sufficient concentration of pigment or filler that sagging is decreased during the curing process.

12. A curable composition comprising:
(A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.;
(B) 0.1-30 PHW of an acid curing system;
(C) 0.1-100 PHW of a reactive diluent component that comprises en epoxy-functional reactive diluent;
the composition exhibiting a room temperature shelf life as a one-pot formulation of about or more than one month.

13. The composition according to claim 12, wherein the reactive diluent component further comprises a polyol diluent.

14. The composition according to claim 12, wherein the composition further comprises a sufficient concentration of pigment or filler that sagging is decreased during the curing process.

15. A commercial package comprising a curable composition with instructions for its use to prepare a gasket, O-ring, potting, stopper, seal, sheet, or coating, wherein the curable composition comprises:
(A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; and
(B) 0.1-30 PHW of a curing system selected from the group consisting of epoxy-curative amine curing systems, acid curing systems, and photoinitiator curing systems.

16. An article made of a material that is the curing reaction product of a curable composition comprising:
(A) 100 PHW of an epoxy-functional acrylic resin comprising epoxy-functional acrylic polymers having an epoxy functionality of at least 3 and an epoxy-equivalent weight from about 500 to 2000, wherein the resin either alone or in admixture with 100 PHE or less of a resin diluent, if present, can exhibit a viscosity of less than 10,000 cP as determined at 25° C.; and
(B) 0.1-30 PHW of a curing system selected from the group consisting of (1) epoxy-curative aza curing systems with room temperature or elevated temperature applied to the composition, (2) acid curing systems with elevated temperature applied to the composition, and (3) photoinitiator curing systems with actinic radiation applied to the composition.

17. The article according to claim 10, wherein the article is a molded or extruded article.

18. The article according to claim 10, wherein the article is a gasket, O-ring, potting, stopper, seal, sheet, or coating.

19. The article according to claim 18, wherein the article is a gasket.

20. The article according to claim 19, wherein the gasket is a “cured-in-place” gasket or a screen-printed gasket.
